(19) United States
(12) Patent Application Publication
(10) Pub. No.: US 2007/0215157 A1
(43) Pub. Date: Sep. 20, 2007

(54) Rebreather Setpoint Controller and Display

(76) Inventor: Philip Edward Straw, Redwood City, CA (US)

Correspondence Address: CASCIO, SCHMOYER & ZERVAS, 423 BROADWAY AVE., STE. 314, MILLBRAE, CA, 94030-1905, US

(21) Appl. No.: 11/579,015

(22) PCT Filed: May 2, 2005
(86) PCT No.: PCT/US05/14734

§ 371 Date: Oct. 30, 2006

Related U.S. Application Data
(60) Provisional application No. 60/567,288, filed on Apr. 30, 2004.

(51) Int. Cl. A62B 7/10

(52) U.S. Cl. 128/205.12

(57) ABSTRACT

An oxygen setpoint controller (SPC) and a user's display for a rebreathing apparatus wherein the user exhales oxygen depleted breath into a closed rebreathing loop, the CO₂ is scrubbed from the exhaled gases, oxygen is added to the rebreathing loop to maintain the oxygen at a specified partial pressure, and the oxygen enhanced gases in the rebreathing are provided to the user. The SPC is able to detect the failure of any of the oxygen sensors and provide an alarm condition to the user. The SPC further operates to provide dive data such as rate of ascent, time of dive, depth, and PPO2 to the uses, and to store and retain dive data for further review. The SPC further provides numerical dive data to a heads up display (HUD). The HUD further includes a tricolor LED displaying selected analog parameters.

### CROSS REFERENCE TO RELATED APPLICATIONS

This application claims priority from U.S. Provisional Application No. 60/567,288 filed on Apr. 30, 2004.

### FIELD OF THE INVENTION

The present invention relates generally to canisters used in self-contained breathing apparatus for containing CO₂ absorbing material. A type of self-contained breathing apparatus, known as rebreathers, may be used by people who encounter hazardous environments such as firefighters, rescue workers, miners, chemical plant workers, or divers.

### BACKGROUND OF THE INVENTION

Self-contained breathing apparatus may be one of several types; open circuit, closed circuit, or semi-closed circuit. An example of the open circuit type is the SCUBA gear worn by many underwater divers typically comprising one or more containers filled with compressed air or other gases, means for regulating or reducing the pressure of the compressed gas from the storage pressure to a pressure that can be breathed by a user, and the necessary hoses and mouthpieces to enable the user to breath the gas at the reduced pressure. The exhaled breath is expelled to the surrounding environment resulting in a loss to the user of all exhaled gases. Air is a mixture of gases and at the two largest components are nitrogen (N₂) and oxygen (O₂) having partial pressures at atmospheric conditions of 78% and 21% respectively. The partial pressure is an indication of the volume of a component gas of a gas mixture, as known through Dalton's Law of Partial Pressures. Other gases comprise the remaining amount including carbon dioxide (CO₂) at 0.033%. During respiration, the air leaving a person's lungs contains 14% O₂ and 4.4% CO₂. Therefore, a user will consume only 7% of the inhaled volume, and all the exhaled volume is exhausted to the environment.

Because only 7% of the inhaled volume is consumed during respiration, and all of the exhaled volume is exhausted, 93% of the aspirated air is “wasted”. A second type of self-contained breathing apparatus overcomes this air “wastage”.

A rebreather overcomes this “wastage” by removing the CO₂ from the exhaled air, providing oxygen to makeup the oxygen consumed by the user, and recycling the CO₂ depleted, oxygen augmented exhaled gas. There are two types of rebreathers; a semi closed circuit rebreather (SCCR) that provides a constant or a manually adjustable flow of oxygen from a reservoir of compressed oxygen through a valve into an inhalant counterlung for mixing with the CO₂ depleted exhaled gas, and a closed circuit rebreather (CCR) that automatically adjusts the volume of makeup O₂ as a function oxygen content of the exhaled gas to maintain a specified partial pressure of oxygen (PPO₂) of the inhaled gas. This specified PPO₂, or PPO₂ setpoint, may be fixed or user adjustable to provide the user with sufficient oxygen for specific conditions.

Both the SCCR and the CCR types also have a second supply of compressed gas, a diluent gas, to maintain the rebreather loop gas volume as a user descends in water, and this diluent gas may be compressed air or other mixtures of gases that enable a user to operate at greater depth. The diluent gas may be added automatically or manually by the user to maintain gas volume when descending or when gas is deliberately exhausted from the system. The diluent gas is usually coupled with a gas buffer or exhalant counterlung by means of valve.

Each type of rebreather is well known and fully described in the art. For example, see U.S. Pat. No. 5,924,418 issued Jul. 20, 1999 to John E. Lewis of Rancho Pales Verde, Calif., U.S. Pat. No. 6,003,513 issued Dec. 21, 1999 to Peter Francis Readey and Michael J. Cochran of Plano, Tex., and U.S. Pat. No. 6,712,071 issued Mar. 30, 2004 to Martin John Parker of Great Britain.

### SUMMARY OF THE INVENTION

This application is directed to the monitoring of the of the oxygen content of the exhaled gas and the controls for injecting oxygen into the exhaled gas to maintained a specified oxygen content of the gas breathed by the user in a closed circuit rebreather. Although rebreathers may be used in a variety of hazardous environments, this invention will be described in the context of underwater environments.

A rebreather comprises a closed breathing loop to capture a user's exhaled gases, to direct the exhaled gases to an exhalant counterlung for receiving the exhaled gases, to remove or “scrub” CO₂ from the exhaled gases in a scrubber coupled with the exhalant counterlung, to inject oxygen into the scrubber, to direct the oxygen enriched breathable gas to an inhalant counterlung, and a mouthpiece coupled to the inhalant and exhalant counterlung for providing breathable gas to the user. The user's lungs provide the energy to circulate the gas around the breathing loop, and one-way valves located in either the mouthpiece or the counterlung couplings ensure the gas flow within the closed breathing loop is unidirectional. Oxygen sensors located within the scrubber enclosure measure the partial pressure of oxygen (PPO2) in the exhaled gases. [0010] The oxygen sensors provide signals representing the PPO2 of the exhaled gas to the setpoint controller (SPC) in which the actual PPO2 can be compared with the desired PPO2. The difference between the actual PPO2 and the desired PPO2 is then used to control the oxygen injection valve to inject oxygen into the scrubber housing to maintain the desired PPO2. The desired PPO2 may be entered manually using a controls handset or the desired PPO2 may be the result of a computer program resident in the SPC to monitor the user's stress.

The SPC drives the oxygen injection valve in accordance with the desired PPO2 and the measure PPO2 in the exhaled gases. The SPC also comprises a microprocessor for storing operational data, providing data to user displays, storing and running decompression models, calibrating the oxygen sensors, and providing alarms and alerts to the user. A handset controller displays selected systems parameters and the values of each of three oxygen sensors, and buttons on the handset controller allows the user to change the desired PPO2 setpoint and display a cycle of systems parameters. The SPC also controls the intensity of the display backlighting as a function of depth or user input. A tri-color light emitting diode may the light source and its intensity may be controlled using a pulse width modulator. Further, the color of the display may be changed, the intensity of the display may be increased, the backlighting may be flashed, or a combination of these may be used to indicate an alarm condition to the user.

The SPC also provides signals to a heads-up display. The heads-up display will display the PPO2 setpoint and other selected parameters. In addition to displaying numerical values, the PPO2 may also be displayed by a tri-color light emitting diode in which the PPO2 or another selected variable will be displayed as a color continuum. Alarm conditions may be shown by flashing colors or a white light.

The oxygen sensors, SPC, the oxygen injection valve, and batteries are located in a watertight chamber in the scrubber canister. A wired or wireless network may provide communications between the SPC and all the sensors, displays and devices thereby reducing the system susceptibility to noise and improving the rebreather performance and reliability. Because the radio frequencies used for wireless networks do not propagate in water, the closed breathing may serve as a wave guide.

### BRIEF DESCRIPTION OF THE DRAWINGS

These and other features, aspects an advantages of the present of the present invention will be more fully understood when considered with respect to the following detailed description, appended claims, and accompanying drawings, wherein:

FIG. 1 is a schematic representation of the setpoint controller showing the interconnections to the oxygen injection solenoid, oxygen sensors, and display devices;

FIG. 2 illustrates the states of the SPC and the transitions therebetween;

### DETAILED DESCRIPTION OF THE INVENTION

Setpoint controller (SPC) for Rebreather

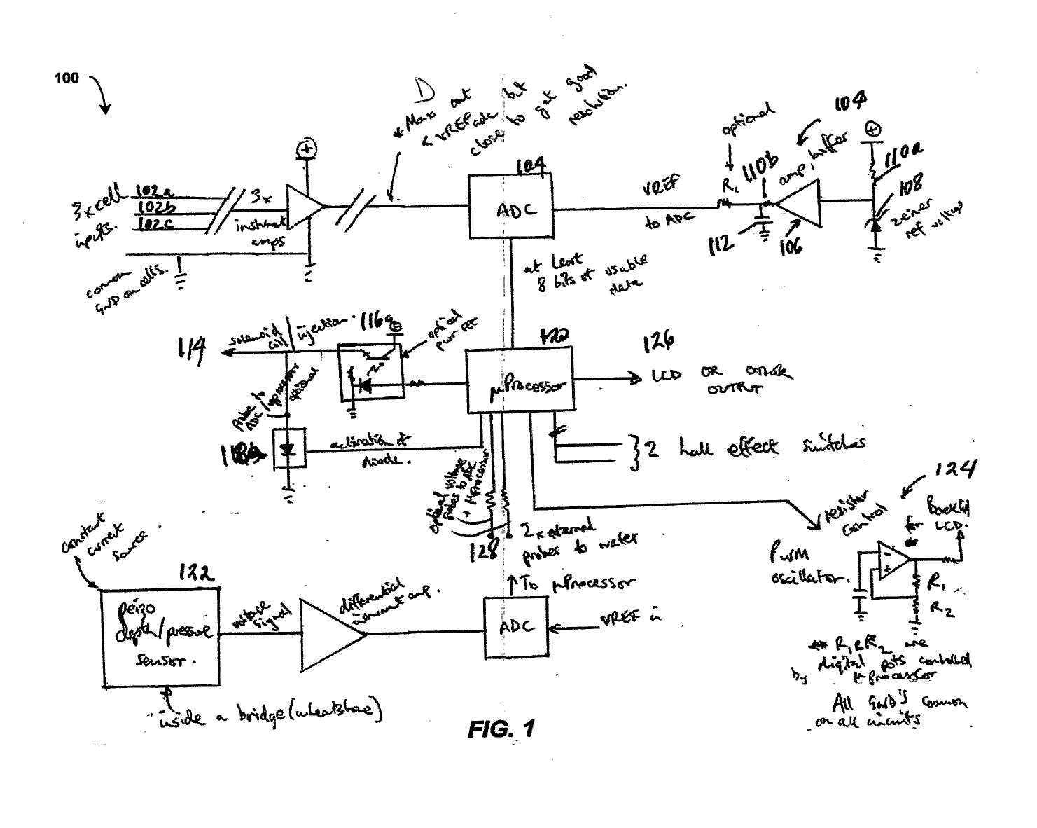

A setpoint controller (SPC) 100 is shown in FIG. 1. Three raw oxygen sensors 102a-c (e.g., Teledyne R22) provide voltage signals proportional to partial pressure of oxygen (PPO2). Analog to digital converter 104 amplifies and converts these analog signals to digital signals for use by the SPC and display to the user. The SPC also provides error detection by comparing the output of each cell with each of the other cells, and selecting a value in which two of the three cells agree with each other within specified parameters. Should a cell's output value indicating oxygen content fall outside the comparison parameters with the other two cells, that cell is presumed to have failed and is excluded from further use.

Because most voltage regulators are not sufficiently accurate to compensate for battery voltage decay through current usage, a precision voltage reference provides increased accuracy. A simplified diagram for the precision voltage reference is shown comprising a common amplifier, a reference zener diode, and two resistors.

The ratio of the two resistors controls the gain of the amplifier. A low pass filter is also provided to remove any extraneous system noise. Because most oxygen sensors are noisy, the instrument amplifier requires common mode rejection of noise from the sensor signals. Providing common mode rejection by using low pass filters or software averaging is well known in the art.

The oxygen injection solenoid 114 is also shown partially in FIG. 1. Two optical power FET drivers supply energizing current to the oxygen injection solenoid and two digitally activated diodes provide dispersion of counter-emf generated by deenergizing the solenoid. A digitally activated diode may be simply a FET used as a switch, turned on and off by the SPC μProc, 120 allowing current to flow through the diode.

By placing a capacitor between the resistor and the input from the μProc, and tying the capacitor to ground it is possible use pulse width modulation to get a variable output using the correct optical isolator. Most solenoid applications require a clean rise and fall of the binary input.

To drive the solenoid open, the optical isolator 116 and the reverse bias diode 118 are digitally activated. When the coil is deenergized, the coil generates a counter-emf current that is quickly dissipated by the reverse bias diode 118. Dissipating the counter-emf current eliminates the biasing of the ground reference thereby providing more reliable solenoid closing. A reverse bias diode 118 also provides the possibility to drive some solenoids in a reverse direction thereby forcing a normally closed solenoid to a partially or fully open condition. Rapid pulsing between the open an closed positions may eventually free a stuck solenoid. The reverse bias diodes on each drive (operated as appropriate for each drive) increase the reliability of most solenoids, thereby mitigating problems with stuck solenoids as known in the current art. A separate ground for the solenoid drive circuit is used minimize or eliminate sensor noise.

A pressure sensor 122 is provided for sensing barometric pressure to aid the calibration process. The oxygen cells 102a-c are calibrated by using a known gas having an oxygen content as close to the proposed setpoint as possible. As currently known in the art, the user automatically injects the known gas to flush the rebreather prior to calibrate the oxygen cells. The user then Waits for a period of time before calibrating the cells. A pressure sensor senses the loop pressure and determines when the loop returns to barometric pressure, thereby minimizing the calibration wait time.

By closing the loop after the oxygen flush, the solenoid can overpressure the loop to check for air leaks. The loop pressure may be monitored over a period of time to detect leaks. The loop pressure may also be set to a specific pressure for oxygen calibration. The SPC also checks the oxygen cell linearity. Calibration can be checked by injecting diluent, or by breaking open the rebreather loop at the cells to allow air over the sensor face.

A display 126 having a backlight is coupled to the SPC. The backlight is a light emitting diode or another similar mechanism that is driven by pulse width modulation. A pulse width modulator 124 is shown in FIG. 1 comprising an amplifier, a timing capacitor and digital potentiometers to control the duty cycle and period. The SPC is then able to control the intensity of backlighting depending upon the intensity of external light by sensing the external light, or user commands. Another means of control is to adjust the backlight as a function of depth knowing less light is needed at depth and hence providing power savings. An additional benefit to the user is a control means to limit light intensity when in low light situations thereby preventing night blindness. The backlight may be activated by the user, by depth, or by light intensity.

the SPC also monitors battery voltages. In the event of a low battery voltage situation, the backlight could be illuminated or dimmed. Additionally to conserve power and to avoid operating the system to failure, the SPC may lower the setpoint to minimize or stop the oxygen injection. The primary display on the SPC will be turned off and a secondary system is used instead informing the user that setpoint control is still working inside bounds.

The set point controller 100 further comprises a ‘wet switch’ 128 or water sensor for SPC activation. The wet switch pulses an output to an output pin into the water and observes the response on an input pin. If the SPC is in water, an input pulse will be observed on the input pin, and the SPC will be activated. The SPC can also determine the salinity of the water by observing the response to the output pulse over a known distance to the input pin. The water salinity provides a correction factor for under water depth adjustment for fresh or variable amounts of salt water.

Time keeping can be tracked for dive time using either the depth sensor or wet switch as a start and end condition. Time tracking is known in the art for such applications. The timing signal also drives a counter and upon a counter overflow condition, causes a processor interrupt. This allows very accurate timing of the solenoid injects. This timer can be adjusted as per the setpoint control logic.

While in an inactive state, the SPC monitors the oxygen and detect breathing on the loop. Breathing detection, wet contact, or depth automatically activates the SPC. Wet contact or depth activation may be switched off manually whereas breathing detection is constantly active.

Because total CO2 production and therefore scrubber absorption is related to oxygen use, the total oxygen injection time and the depth can be correlated to signify stress, CO2 increase, or workload. Timing the total oxygen injection activity provides an accurate tracking of the use of the scrubber if measured with depth. Correlation of this information with depth can give an approximation of scrubber life left, or use to date if the scrubber mechanics were previously understood. This value could be used to alert the user to a low remaining scrubber life, with an indication that the user should surface to replenish the scrubber or to recheck calibration as required..

Scrubbing CO2 is an exothermic reaction and generates heat and the temperature of an axial scrubber can be monitored. A novel way of sensing the scrubber temperature with precision is by using use of a strip or printed circuit board of solid state temperature sensors on a data bus mounted along the axis of the scrubber. For example I2C data bus sensors are available. Radial scrubbers could use the same technique with an alternative arrangement of sensors. These temperature sensors identify the location of the warm front of the reaction of the following cold front thereby providing the breadth of the hot front.

At depth, the breadth of the hot front will increase to process and completely remove CO2, and determining the unused amount of the scrubber that is left that is limits the maximum time before the reaction reaches the end of the scrubber causing release of CO2 into the rebreather loop. As the diver moves from depth to the shallows the warm front can move backwards because the lower density gas can be scrubbed in less flow volume (e.g., length in an axial scrubber). Now this movement up the scrubber stack allows for an increased time of use (having ascended) before the front reaches the end of the scrubber stack. This data is presented in terms of duration remaining and maximum depth of use of the scrubber in current conditions. Rate of progression of the front for a given depth can be taken and extrapolated to give an end of lifetime. A safe exit for a depth is determined by comparing the “ceiling” of ascent (when ascent limitations are known, for example, as a result of a decompression model computation) and compared to the “lifetime” of the scrubber.

SPC States

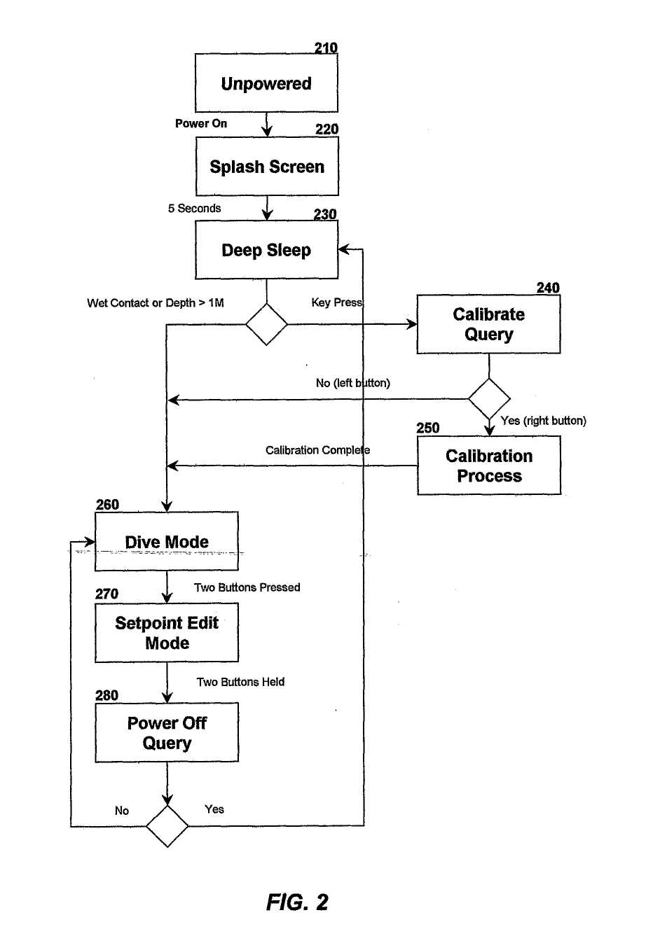

The controls handset is the user interface (UI) comprising a display screen and two user depressible buttons for transitioning from state to state and is usually located remotely from the SPC typically on the user's wrist. The states for the SPC are shown in FIG. 2. In the unpowered condition 210, the display screen is blank. Upon powering, a splash screen 220 is presented to the user to confirm the SCP is active. After five seconds, the SPC reverts to a deep sleep 230 and again presents a blank screen to the user. Upon a second key press, the SPC queries the user 240 whether to proceed to the calibration process 250. The user presses the right button to calibrate 250 and the left button to proceed to the dive mode 260. When the calibration process completes, the SPC is now locked in the dive mode 260. The user depresses both buttons to unlock the dive mode 260 enter the setpoint edit mode 270 and allows the user to change the PPO2 setpoint. Pressing one button or the other raises or lowers the PPO2 setpoint. If both buttons are held for longer than three seconds, the SPC queries the uses whether to turn off the power 280. Upon the proper response from the user, the SPC returns the deep sleep state 230. To prevent from accidental off signals the SPC UI asks for a random button to be pressed, so as not to build user habits. If the power off response is not received, the SPC returns to the dive mode 260. The UI always displays PPO2 in the dive mode 260, and depth, time, and ascent rate displays are available to the user.

Alarms and alerts are displayed to the user by flashing the backlight, varying brightness or using different colors to signal different events and alarm warnings.

Component placement is an important consideration for an underwater environment. The oxygen sensors, the oxygen injection valve, the batteries and are located in a dry chamber of the scrubber. However the SPC may be located external to the scrubber. Because the raw signals from the oxygen cells are remote to the SPC, the signals are particularly susceptible to noise, particularly if the sensor signals are co-located on the same wire as the power to a high current device such as the oxygen injection solenoid. To overcome the susceptibility to noise, the oxygen injection solenoid driver is placed adjacent to the solenoid itself Therefore, the solenoid actuation signal is a low current signal. Alternatively, or in addition to placing the solenoid driver circuitry adjacent to the solenoid, local pre-amplifiers are placed next to the oxygen sensors,

The addition of a current limiting resistor to the reference voltage amplifier can detect water leakage within the SPC, For example, when the resistor is large and salt water leaks into a cable, the resistor acts as a current limiter and the reference voltage would likely be driven to ground. The SPC logic can detect this voltage drop and indicate a water leak.

Another embodiment to reduce noise or the susceptibility to noise is locate the SPC within the scrubber canister.

Still another embodiment to reduce noise is to couple the oxygen sensors, the handset controller, the SPC, and other sensors using a digital communications protocol operating over a wired or a wireless network. A digital protocol is inherently less susceptible to noise, and can operate in noisy environments. Error correction techniques for operating digital communications networks in noisy environments are well known in the art.

While the communications network may be implemented using a wired bus, another implementation is to use a wireless network. Radio waves propagate in air, not water, and a wireless network may propagate its signals in the closed breathing loop. Each device such as the oxygen sensors and SPC would be connected to the network using a radio frequency bridge, and communicate to each other using radio waves in the closed breathing loop. A wave guide separate from the close breathing loop may alternatively be supplied.

Setpoint control is based on an injection period and a duty cycle inside that period. This approach allows the period to be altered to accommodate the minimum injection time at depth, for example by limiting the control by depth and set a smaller injection period. The potential for setpoint overshoot also may be accurately controlled. If the PPO2 is close to the setpoint, the injection duty cycle can be held constant to the oxygen injector minimum opening time and adjusting the period. For example, a depth decrease may cause an increase in the duty cycle for the next specific number of periods.

Another advantage is the ability to reduce the setpoint when it is not possible to achieve the setpoint. Such a condition occurs when the user is on the surface and the setpoint is trying to control a PPO2 of 1.3. Another example is to protect against under-calibration. If, for example, pure oxygen was not available for calibration, and if a user dives to 6M and achieves a displayed 1.8 PPO2, it would be possible to correct the values for mis-calibration or give an alarm

Over time, calibration values could be stored in the SPC flash memory and compared to show a decay over time or an indication of the cell accuracy in different conditions. The rate of change for the oxygen cell values could be monitored against a known good curve for those conditions. At intervals, the oxygen cells could also be tested by shorting each cell allowing each cell to produce the maximum rated current.

Old cells would not be able to reach the rated current, or when the short was removed, would not be able to reach the previous voltage for the PPO2 condition thereby indicating a cell reaching the end of life or another condition of mistrust. This technique is compatible with underwater use and is achieved by using a FET switch and a resistor tuned for the current voltage across the cell such that it passed the maximum current under the cell specification.

Heads Up Display (HUD)

The SPC also drives a heads up display located within the user's line of sight. The drive would require balancing resistors to achieve equal brightness on all legs of the LEDs, with a common ground being connected to a pulse width modulator from the SPC to effect overall brightness.

For example a tricolor LED (RGB) could be used to display any range of colors in the spectrum. Discrete use of specific colors show specific conditions, for example blue=cold=hypoxic mix or close, green=near setpoint, red=hot mix=hyperoxic or close. Color changes could be discrete or continuous to indicate condition changes. A different color indicates an alert or calibration display. A hall effect button could be used to make more ambitious function changes in the display if necessary

The LED could be watertight and on the end of a 4 wire cable. By making the plastic slightly opaque on the surface the light is diffused. A reflective section is placed internally within the LED hole to make the whole housing produce a diffused glow and thereby provide a signal to a buddy. The signal is naturally intuitive, qualitative, and easy to read. A flashing LED indicates an SPC failure and the color indicates the value of the PPO2. In addition to the color indication, the flashing rate may also be used to indicate the qualitative value.

The SPC multiple battery sources, for example driver circuit battery is separate from the HUD battery. The batteries are cross-coupled so that power to the HUD could be supplied by the SPC battery thereby enabling a PPO2 monitoring system in the event the HUD battery fails. When the SPC battery in this case decays, the HUD could alert the user with an alert thereby providing an early warning of the solenoid drive battery decay and failure.

Calibration of the HUD could be done on a signal from the SPC controller. It could also be done by monitoring the solenoid drive signal. This could also allow signaling of the oxygen injection valve on the HUD. An example of this would be to look for 10 seconds of requested drive, watch for inactivity on the drive request, wait a small period, then read calibration values.

The PPO2 displayed on the HUD or SPC may be the average of the two closest cells as per the state of the art. Another embodiment is to average all three cells when the values are close. Another embodiment is to discount all untrusted cells as determined by the aforementioned tests. An alarm condition exists when less than two cells are trusted, and this alarm is displayed to the user.

A waterproof data port is provided for establishing electrical or optical connections to other rebreathers or devices. This allows external monitoring of the rebreather conditions, remote control of the SPC, updating of software, or user to user communications. A digital protocol is used on the port, for example I2C or multi-master/multidrop.

I claim:

1. A self-contained breathing apparatus comprising:
a rebreather loop further comprising a breathing mouthpiece for allowing a user to breathe, said breathing mouthpiece having an inlet connected through a first one-way valve, and the mouthpiece having an outlet for passing exhaled gas through a second one-way valve; an exhalant counterlung connected to the second one-way valve for receiving the exhaled gas; a scrubber connected to the exhalant counterlung for receiving the exhaled gas and for removing CO₂ from the exhaled gas, and connected through an oxygen injection valve to a first cylinder of compressed gas for receiving O₂ enriched gas; and an inhalant counterlung connected to the scrubber for receiving the CO₂ depleted gas from the scrubber, and connected to a second cylinder of compressed gas for receiving a diluent gas, and connected to the first one-way valve for providing breathable gas to the user;
an oxygen monitoring system for measuring the 02 partial pressure (PPO2) of the CO₂ depleted exhaled gas; and
an oxygen control system coupled to the oxygen monitoring system for injecting O₂ enriched gas from the first cylinder to the inhalant counterlung.

2. The self-contained breathing apparatus as claimed in claim 1 in which the oxygen control system further comprises an oxygen setpoint controller coupled with a water depth pressure sensor, a controls handset, an oxygen partial pressure (PPO2) display.

3. The self-contained breathing apparatus as claimed in claim 2 in which the oxygen setpoint controller receives a first signal from the oxygen monitoring system and a second signal from the water depth pressure sensor, compares the first signal to a desired PPO2 reference signal that is biased by the second signal, provides a third signal to the oxygen injection valve, and provides a fourth signal to the PPO2 display.

4. The self-contained breathing apparatus as claimed in claim 3 in which the oxygen setpoint controller provides decompression information thereby allowing the user to safely ascend from a dive by avoiding blood outgassing.

5. The self-contained breathing apparatus as claimed in claim 3 in which the PPO2 display provides a quantitative measurement of a selected parameter of the oxygen control system.

6. The self-contained breathing apparatus as claimed in claim 5 wherein the selected parameter is the PPO2 of the breathable gas.

7. The self-contained breathing apparatus as claimed in claim 5 wherein the selected parameter is a percentage of an ascent limiting factor.

8. The self-contained breathing apparatus as claimed in claim 5 wherein the selected parameter is ceiling depth.

9. The self-contained breathing apparatus as claimed in claim 5 wherein the selected parameter is time to the surface.

10. The self-contained breathing apparatus as claimed in claim 5 wherein the PPO2 display comprises a heads-up-display (HUD) mounted in a diving mask worn by the user.

11. The self-contained breathing apparatus as claimed in claim 5 wherein the PPO2 display is located on the controls handset.

12. The self-contained breathing apparatus as claimed in claim 11 wherein the PPO2 display is a liquid crystal display (LCD) having an illumination LED for backlighting.

13. The self-contained breathing apparatus as claimed in claim 12 wherein the illumination LED is blue.

14. The self-contained breathing apparatus as claimed in claim 12 wherein the backlighting is varied by pulse width modulating the illumination LED.

15. The self-contained breathing apparatus as claimed in claim 14 wherein the backlighting is increased or decreased by the controls handset.

16. The self-contained breathing apparatus as claimed in claim 14 wherein the backlighting is varied depending upon ambient light conditions.

17. The self-contained breathing apparatus as claimed in claim 12 wherein the backlighting is switched from a constant condition to a variable condition by the controls handset.

18. The self-contained breathing apparatus as claimed in claim 5 wherein the PPO2 display comprises a tricolored light emitting diode capable of displaying a specific color depending upon the magnitude parameter being displayed.

19. The self-contained breathing apparatus as claimed in claim 18 wherein the PPO2 display is visible by the user.

20. The self-contained breathing apparatus as claimed in claim 18 wherein the PPO2 display is visible on the user by others.

21. The self-contained breathing apparatus as claimed in claim 2 wherein the setpoint controller further comprises a processor having protected memory whereby the protected memory is protected from reading and from reprograming.

22. The self-contained breathing apparatus as claimed in claim 21 wherein the protected memory contains a serial number assigned to the self-contained breathing apparatus and a license key for authenticating software residing within the setpoint controller.

23. The self-contained breathing apparatus as claimed in claim 21 wherein the setpoint controller further comprises at least one software program to emulate decompression models.

24. The self-contained breathing apparatus as claimed in claim 23 wherein all decompression models are simultaneously operable.

25. The self-contained breathing apparatus as claimed in claim 24 wherein each decompression model has an output showing ascent rate.

26. The self-contained breathing apparatus as claimed in claim 25 wherein the output of the one decompression model having the minimum ascent rate is displayable on the PPO2 display.

27. The self-contained breathing apparatus as claimed in claim 23 wherein a single decompression model is operable.

28. The self-contained breathing apparatus as claimed in claim 27 wherein the single decompression model has an output showing ascent rate, the ascent rate being displayable on the PPO2 display.

29. The self-contained breathing apparatus as claimed in claim 21 wherein the setpoint controller comprises at least one software program to emulate user training modes.

30. The self-contained breathing apparatus as claimed in claim 29 wherein the user training modes comprise a simulated failure of the oxygen sensing system and a simulated failure of the oxygen injection valve.

31. The self-contained breathing apparatus as claimed in claim 2 wherein the setpoint controller Other comprises an optical power diode to supply power to the oxygen injection valve.

32. The self-contained breathing apparatus as claimed in claim 2 in which the oxygen sensing system the setpoint controller, the oxygen injection valve, the controls handset, and the PPO2 display are coupled using a digital communications protocol.

33. The self-contained breathing apparatus as claimed in claim 32 in which the digital communications protocol operates over a wired bus.

34. The self-contained breathing apparatus as claimed in claim 32 in which the digital communications protocol operates over a wireless radio frequency operating in the rebreather loop.

35. The self-contained breathing apparatus as claimed in claim 34 in which the wireless radio frequency operates using a wave guide.
